(19) United States
(12) Patent Application Publication
(10) Pub. No.: US 2010/0174815 A1
(43) Pub. Date: Jul. 8, 2010

(54) METHOD AND APPARATUS FOR NETWORK LICENSE ENFORCEMENT

(76) Inventors: Ryan Pershing Norwood, Blacksburg, VA (US); Joseph Ruscio, San Francisco, CA (US)

Correspondence Address: Arent Fox LLP, 555 West Fifth Street, 48th Floor, Los Angeles, CA, 90013, US

(21) Appl. No.: 12/631,723

(22) Filed: Dec. 4, 2009

Related U.S. Application Data
(60) Provisional application No. 61/142,614, filed on Jan. 5, 2009.

(51) Int. Cl. G06F 15/16

(52) U.S. Cl. 709/226

(57) ABSTRACT

A method for license enforcement is provided. The method includes receiving a license request from an application instance; determining whether the license request is permitted by generating a first response permitting or denying the license request; delivering the license request to a server based upon the first response; receiving a server response from the server permitting or denying the license request; and determining whether the license request is permitted by generating a second response permitting or denying the license request based on the server response. An apparatus for performing the method is also disclosed herein.

### CLAIM OF PRIORITY UNDER 35 U.S.C. §119

The present Application for Patent claims priority to Provisional Application No. 61/142,614, entitled “Method for Transparent Network License Enforcement” filed Jan. 5, 2009, and assigned to the assignee hereof and hereby expressly incorporated by reference herein.

### BACKGROUND

I. Field

The following description relates generally to a method for transparent network license enforcement.

II. Background

Floating licenses are requested and granted over the network to temporarily enable execution of an application instance on any compatible hardware. Floating licenses enable an IT department to purchase hardware in greater quantity than application licenses and multiplex the licenses across said hardware. Software licenses are expensive and this sharing prevents needless over-provisioning and waste of capital. In order for an instance to execute it must first successfully acquire a floating software license through a request to some centralized license server. The license server tracks how many licenses are currently in use, and if one is available grants an unused license to the requesting instance. Each instance periodically communicates with the license server at some frequency to make sure it retains control of its licenses. Typically the license server ensures there are never more instances executing on the network than allowed by the total number of licenses.

Outside from the instances and license server, a higher-level resource management system is usually in place as well. The management system schedules instances across a group of hardware. It makes scheduling decisions that optimize system resources (CPU, memory, licenses, etc) as well as more sophisticated decisions such as maintaining multiple priority levels. The management system schedules instances to execute in some order and upon execution an instance attempts to acquire a license from the license server. In this arrangement there are two independent entities making decisions around the availability of a single resource, licenses. Absent some standard shared mechanism to coordinate access to said single resource, classic race conditions arise. The management system schedules instances based on a perceived availability of licenses, but has no control over instances executed through other mechanisms (manually executed, another management system, etc). Resource managers end up under-scheduling instances to avoid potential license contention (over-provisioning), or over-scheduling them (under-provisioning) so that instances end up consuming the other resources they were scheduled on, while blocking on license acquisition.

The license server and instance operate in an unsophisticated yet tightly closed communication loop. No palatable mechanism exists to increase the sophistication of the license server beyond a simple permit/deny based on license availability. Thus, there currently exists no universal or application transparent solution for effectively managing and enforcing network licenses. The current state-of-the art capabilities in floating license management do not adequately address all of the potential license management scenarios.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect relates to a method for license enforcement. The method may include receiving a request for a license from an instance. The method may also include determining whether the license request is permitted by generating a first response permitting or denying the license request. In addition, the method may include delivering the request to a license server based upon the first response. Moreover, the method may include receiving a server response from the server permitting or denying the license request. Furthermore, the method may include determining whether the license request is permitted by generating a second response permitting or denying the license request.

Another aspect relates to an apparatus for license enforcement. The apparatus may include means for receiving a license request from an application instance. The apparatus may also include means for determining whether the license request is permitted by generating a first response permitting or denying the license request. Further, the apparatus may include means for delivering the license request to a server based upon the first response. Additionally, the apparatus may include means for receiving a server response from the server permitting or denying the license request. Moreover, the apparatus may include means for determining whether the license request for the license is permitted by generating a second response permitting or denying the license request.

Yet another aspect relates to an apparatus for license enforcement. The apparatus may include a memory for storing licenses. In addition, the apparatus may include a processing system configured to: receiving a license request from an application instance; determining whether the license request is permitted by generating a first response permitting or denying the license request; delivering the license request to a server based upon the first response; receiving a server response from the server permitting or denying the license request; and determining whether the license request is permitted by generating a second response permitting or denying the license request.

Still another aspect relates to a computer-program product for license enforcement including a machine-readable medium. The machine-readable medium may be encoded with instructions executed by a processor to cause the processor to: receive a license request from an application instance; determine whether the license request is permitted by generating a first response permitting or denying the license request; deliver the license request to a server based upon the first response; receive a server response from the server permitting or denying the license request; and determine whether the license request is permitted by generating a second response permitting or denying the license request.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

These and other sample aspects of the disclosure will be described in the detailed description that follow, and in the accompanying drawings, wherein:

FIG. 1 is a diagram illustrating a closed loop system;

FIG. 2 is a diagram illustrating a license enforcement inserted transparently in to the closed loop system as in FIG. 1 in accordance with one aspect of the disclosure;

FIG. 3 is a diagram illustrating an exemplary methodology that facilitates a license enforcement mechanism in accordance with another aspect of the disclosure;

FIG. 4 is a diagram illustrating an exemplary mechanism including a single dynamic library in accordance with yet another aspect of the disclosure;

FIG. 5 is a diagram illustrating an exemplary mechanism including dual dynamic libraries in accordance with yet another aspect of the disclosure;

FIG. 6 is a diagram illustrating an exemplary mechanism including a dynamic library and proxy daemon in accordance with another aspect of the disclosure;

FIG. 7 is a block diagram illustrating an example of a hardware configuration for a processing system for license enforcement in accordance with an aspect of the disclosure; and

FIG. 8 is a block diagram illustrating an apparatus for license enforcement in accordance with an aspect of the disclosure.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

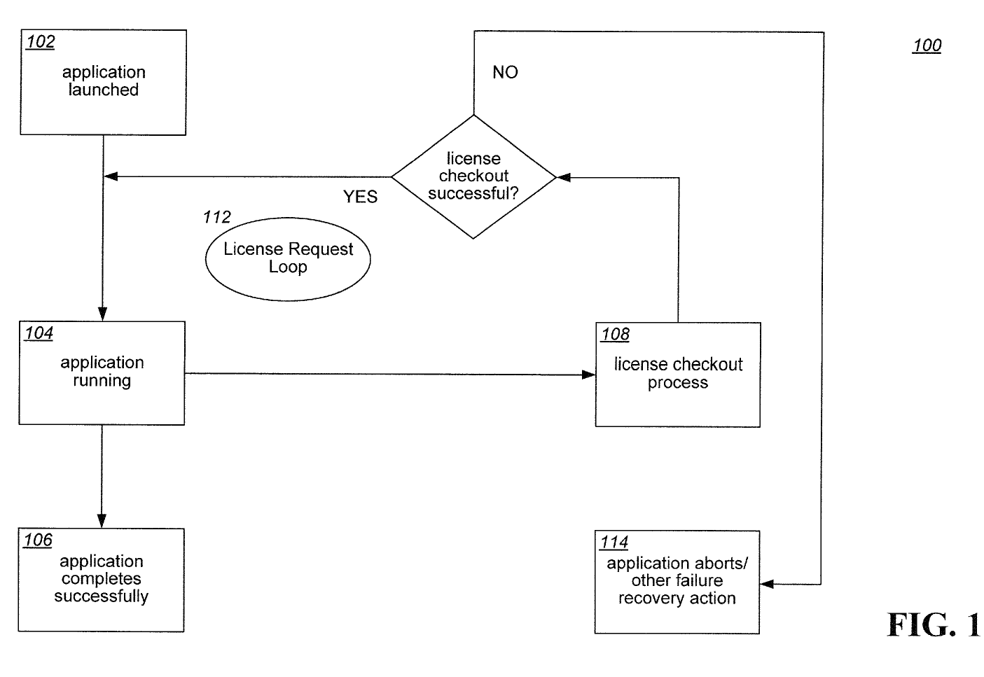

An approach that currently exists is a management system with a separate license tracking mechanism. This approach involves the management system implementing its own license tracking mechanism that shadows the tracking performed by the license server. The management system synchronously polls the license server to keep its shadow information in sync. Instances requiring licenses must register these specific requirements before being scheduled. Once launched, the management system internally updates its shadow information to reflect the consumption of the registered licenses. FIG. 1 is a diagram 100 illustrating a closed-loop system as it currently exists.

In steps 102 and 104, an application is launched and running. In an aspect, the application running may request a license during execution of the application. If the application requests a license, request loop 112 may commence. At step 108, a license checkout process occurs by the license server. The license server may track how many licenses are currently in use, and if one is available, the license server may grant an unused license to the requesting application. Then, at step 110, a determination occurs whether the license checkout was successful. If the license check out was successful, the flow continues back to step 104 where the application continues to run. Next, at step 106, the application may complete execution successfully. However, if the license checkout process was not successful, at step 114, the application aborts or another failure recovery action occurs.

This approach requires instances to know a priori how many licenses they need. Certain applications have dynamic needs based on events that occur after execution commences. This approach further requires instances with static requirements to correctly identify the quantity and type of required licenses. The application may checkout more or different licenses than have been reserved for it. This approach requires all instances be scheduled through the management system. Otherwise, an instance launched outside the management system that directly contacts the license server will create a classic race condition.

In another current approach referred to as an integrated license server communication Application Programming Interface (API), changes to the application and license server are required. These changes implement a coordination mechanism between the license server and management system. The license server relays requests through the API to the management system. The management system works with the license server grant or deny the request while precluding any race conditions.

This approach does not support legacy installations and many users will not upgrade their production infrastructure. This approach also requires every application to support the API. Even if users are willing to application upgrade all their legacy applications, certain Independent Software Vendors (ISV) may choose to not provide such an upgrade.

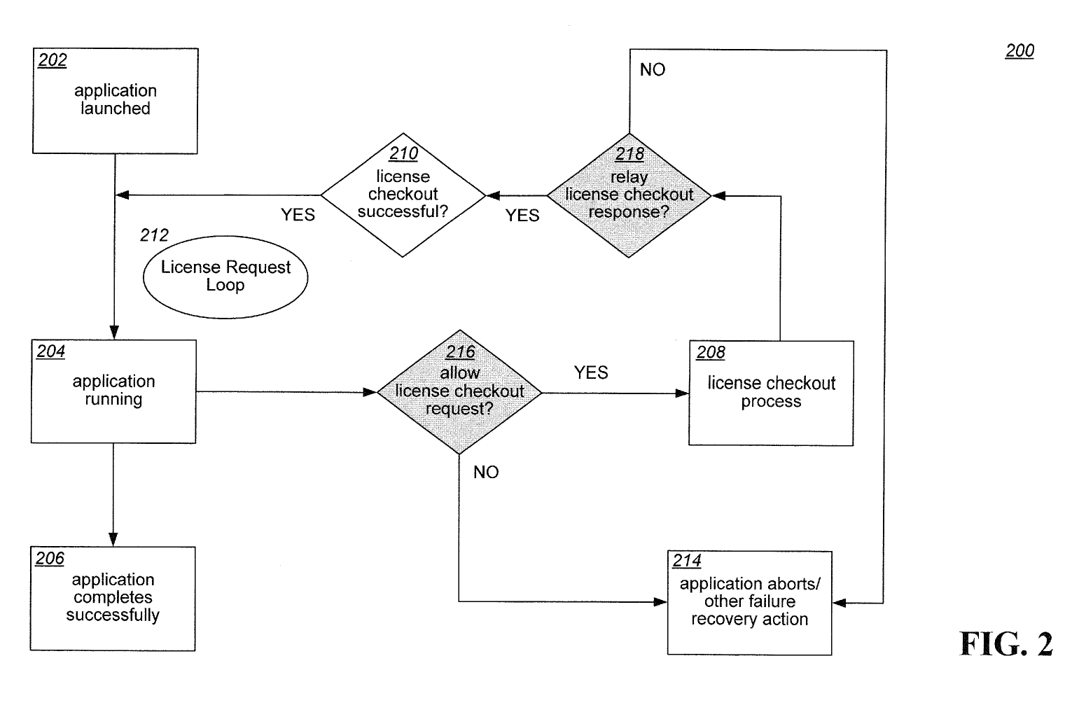

Referring to FIG. 2, illustrated is a diagram 200 illustrating a transparent mechanism for license enforcement inserted transparently into the same closed loop system 100 as in FIG. 1 in accordance with an aspect. The transparent mechanism may be interposed into the closed-loop between an application instance and the license server without requiring any changes to legacy installations. After interposition, the mechanism has the ability to permit or deny license requests by controlling which instance requests are allowed to reach the license server and complete the loop. Likewise the resulting response from the license server can be intercepted and passed to the decision component. Again the method has the ability to permit or deny the request by dropping the connection at this point as well.

In another aspect, the transparent mechanism may use a decision component that determines if a specific request from an instance or response from the license server should be permitted or denied. The decision component takes a set of parameters as input and produces a result of either Permit or Deny response. The decision component may or may not be integrated into a management system. Further, the logic of the decision component can be dynamically configurable or static depending on the level of integration with the management system or other license policy.

Turning now to FIG. 2, in steps 202 and 204, an application is launched and running on a computing system. If the application requests a license, request loop 212 may commence. In an aspect, the transparent mechanism is interposed into the loop between an application instance and the license server without requiring any changes to legacy installations. At step 216, the mechanism has the ability to permit or deny license requests from the application by controlling which instance requests are allowed to reach the license server and complete the loop. If the license is denied by the license enforcement mechanism, then the application aborts or other failure recovery actions occur, at step 214.

However, if the license is permitted by the license enforcement mechanism, at step 208, a license checkout process occurs by the license server. The license server may track how many licenses are currently in use, and if one is available, the license server may grant an unused license to the requesting application. Likewise the resulting response from the license server can be intercepted and passed to the decision component, at step 218. Again the method has the ability to permit or deny the request by dropping the connection at this point as well. Thus, if the request is denied, at step 214, the application aborts or other failure recovery actions may occur. However, if the request is permitted, at step 210, a determination occurs whether the license checkout was successful. If yes, the flow continues back to step 204 where the application continues to run. Next, at step 206, the application may complete execution successfully. However, if the license checkout process was not successful, at step 214, the application aborts or other failure recovery action occur.

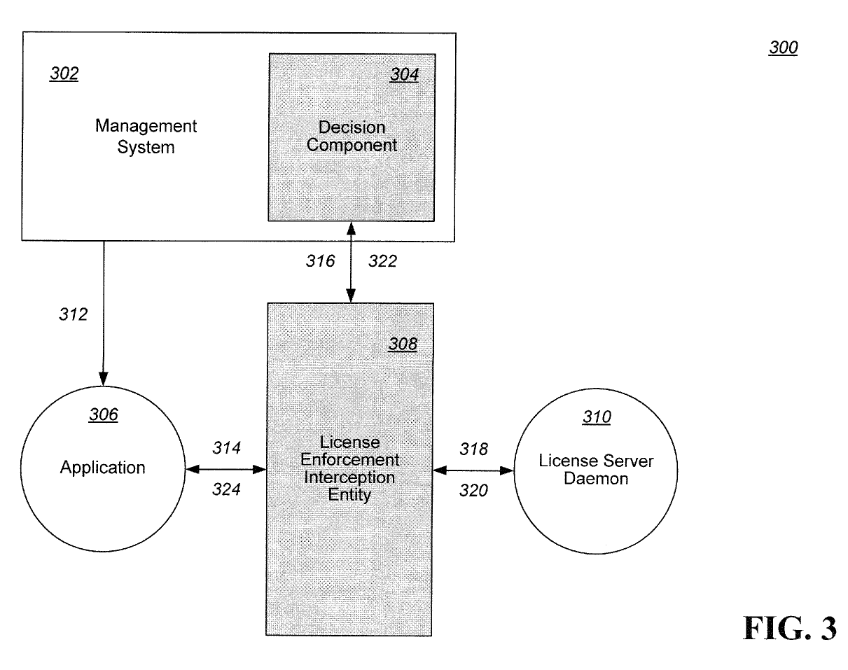

Turning now to FIG. 3, illustrated is an example methodology 300 that facilitates a license enforcement mechanism in operation in accordance with an aspect. It should be appreciated that methodology 300 may be applied to the various aspects discussed herein. At step 312, management system 302 launches an instance. Then, at step 314, application 306 requests a license from the license server. License enforcement entity 308 receives the request for a license from application 306, and at step 316, license enforcement entity 308 queries decision component 304 for a permit or deny decision on the request for the license. License enforcement entity 308 intercepts the response permitting or denying the license from decision component 304. In determining whether to grant a permit or deny on the request for the license, decision component 304 may, for example, interface with management component 302 to determine whether the license is available, what system resources may be available, the priority of the license, and whether other instances have requested the license, among other decision factors.

Decision component 304 can either be dynamic, which may make decisions in real-time based on any number of variables; or static, which may be based on lists of allowed hosts, applications, users, etc. Although the specific factors that determine a dynamic license decision may be based on a particular implementation, they would most often be based on such factors as: priority of the specific application requesting the license; availability of the license in question; policies that may limit the usage of certain licenses to a specific group of users or project groups of which the application in question may be a member; as well as many other factors.

Next, at step 318, if decision component 304 permits the license, license enforcement entity 308 forwards the request for the license to license server 310. License server 310 determines whether to grant the license request. In determining whether to grant the license, license server 310, for example, may track how many licenses are currently in use, and if one is available, grant an unused license to the requesting instance, among other determining factors. Then, at step 320, license server 310 sends a response permitting or denying the license where license enforcement entity 308 intercepts the response from license server 310. Next, at step 322, license enforcement entity 308 queries the decision component for a permit or deny decision on the response from license server 310. If decision component 304 permits the license request, at step 324, license enforcement entity 308 delivers the response to the instance.

The aspect outlined above enables the transparent overlay of any license management scheme on the license server's existing simple scheme. The aspect achieves this without requiring modifications to the license server or software application. A management system integrates with or provides the decision component implementation to gain control of the previously opaque closed loop of the license server and instance. This enables race-free coordination between the management system scheduling of license resources, and the license server granting/denying requests made by the instances themselves.

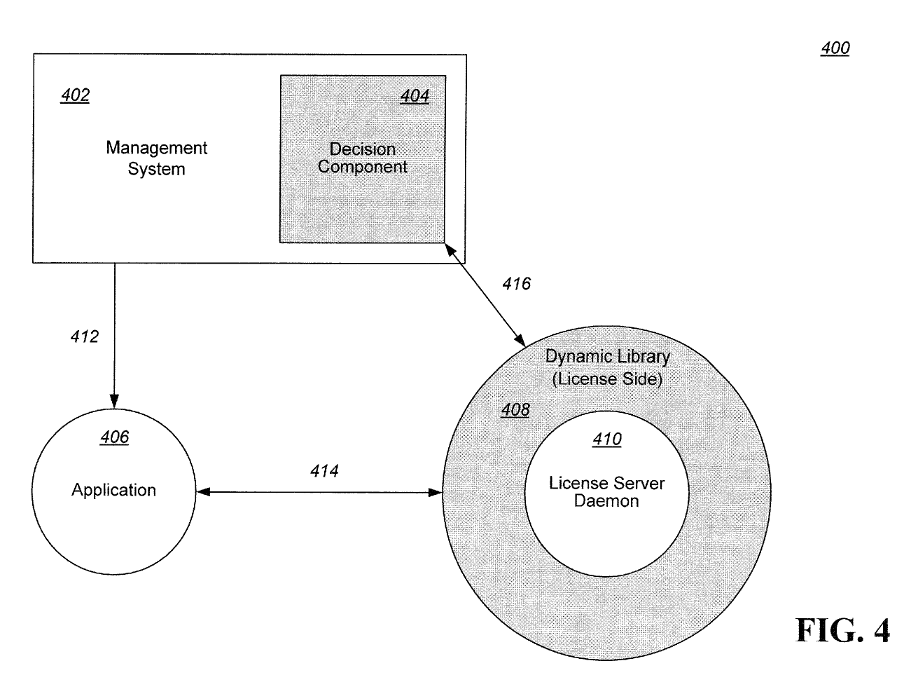

Referring now to FIG. 4, illustrated is an exemplary mechanism 400 operable for license enforcement in accordance with an aspect. Mechanism 400 may include dynamic library 408 that may be integrated into an unmodified license server 410 through any number of standard instrumentation methods. In an aspect, dynamic library 408 may be implemented in the Operating System or Virtual Machine Hypervisor and retain transparency to the application and license server, the benefit of a dynamic runtime library is complete transparency to the entire legacy software stack.

Mechanism 400 may include management system 402, application 406, license server 410 and dynamic library 408. Management system 402 may further include a decision component 404. In an alternative aspect, decision component 404 may be removed from management system 402. Management system 402 may communicate via 412 with application 406 and via 416 with license server 410. Moreover, license server 410 may communicate via 414 with application 406. Dynamic library 408 may be integrated with license server 410 and intercepts all communication operations made to and from license server 410, e.g. communications via 416 from management system 402 and communications via 414 from application 406. Dynamic library 408 may intercept communication operations by trapping software invocations of system calls or other communication libraries. For example, dynamic library 408 could intercept license server invocations of the accept( ) system call on a BSD sockets based platform. When a request is received by dynamic library 408, dynamic library 408 communicates with decision component 404 over any suitable communication mechanism. If an instance request is permitted by decision component 404, the request is allowed to continue on to license server 410. If the request is denied by decision component 404, the request is terminated without ever reaching license server 410, e.g. dynamic library 408 could close( ) the connected socket without ever returning it to the license server layer that invoked the accept( ). Similarly, dynamic library 408 may intercept the response from license server 410 back to the instance, e.g. application 406. Again decision component 404 would make the determination whether to allow the communication to continue based on the contents of the response. For example, depending on the level of encryption, the contents of the response may need to be inferred through an outside inquiry to license server 410. If decision component 404 denies the response, the response is discarded rather then forwarded to the instance.

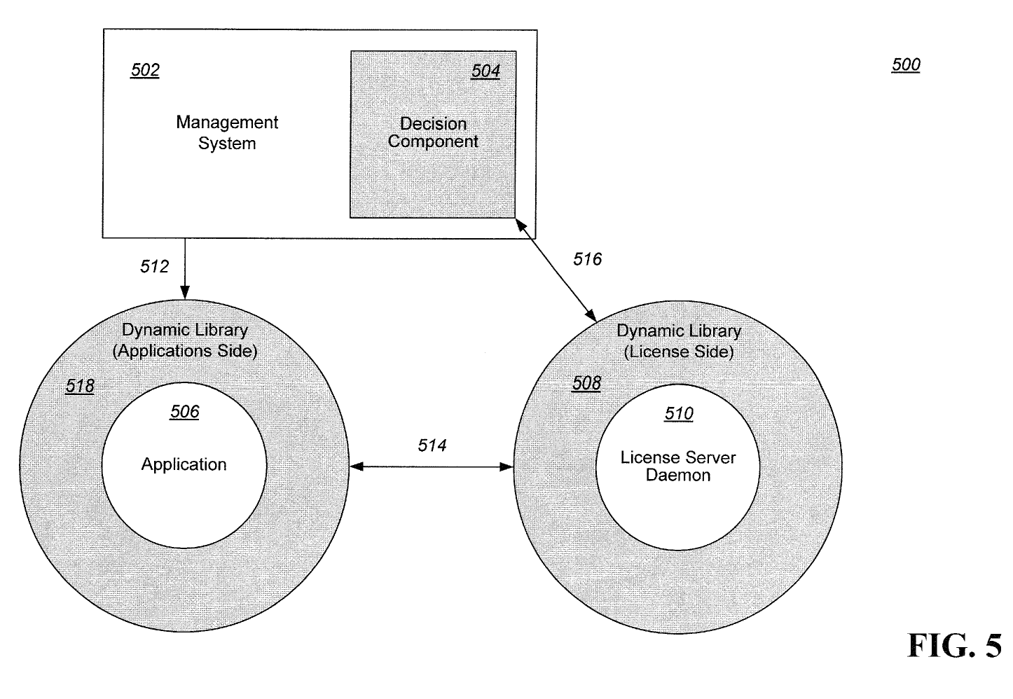

Turning now to FIG. 5, illustrated is an exemplary mechanism 500 building upon mechanism 400 described in relation to FIG. 4 in accordance with an aspect. In addition to library 508 on license server 510 side, a second dynamic library 518 would be preloaded with application 506. Dynamic library 518 would also provide transparency to application 506 as well as the operating system and/or hypervisor. Preloaded dynamic library 518 would enable the collection and transfer of additional information potentially unavailable to decision component 504 if license server 510 was only preloaded with dynamic library 508. This information could include, for example, specifics about the application such as user, controlling terminal, application environment, and any other data deemed valuable at the time. The information would be gathered during the execution of the preloaded dynamic library's 518 constructor and at other critical points during execution through the interception of system calls, e.g., communications via 512 with management system 502 and communications via 514 with license server 510.

In addition, a handshake could be implemented between the respective interposition layers of an application instance 506 and license server 510 for each socket that is connected. The handshake would provide security and the mechanism for the additional information gathered from the instance side to be transferred to the server side prior to the license request.

The advantage provided by this aspect is the ability to have control over every step of the license checkout process while maintaining complete transparency to the system and all software components involved. When integrated with decision component 504, management system 502 would be able to fully exercise this control over the license resources.

In an aspect, management system 502 may launch a job and insert a specific identification key within its environment. The identification key would be read by the preloaded dynamic library 518 on application 506 and then passed to the preloaded library 508 on license server 510. The identification key would then be relayed back to decision component 504 that would be integrated into management system 502 allowing decision component 504 to associate specific license requests with application 506 making the request. This scenario would enable a higher level of control and allow the management system to make very specific and accurate resource scheduling decisions.

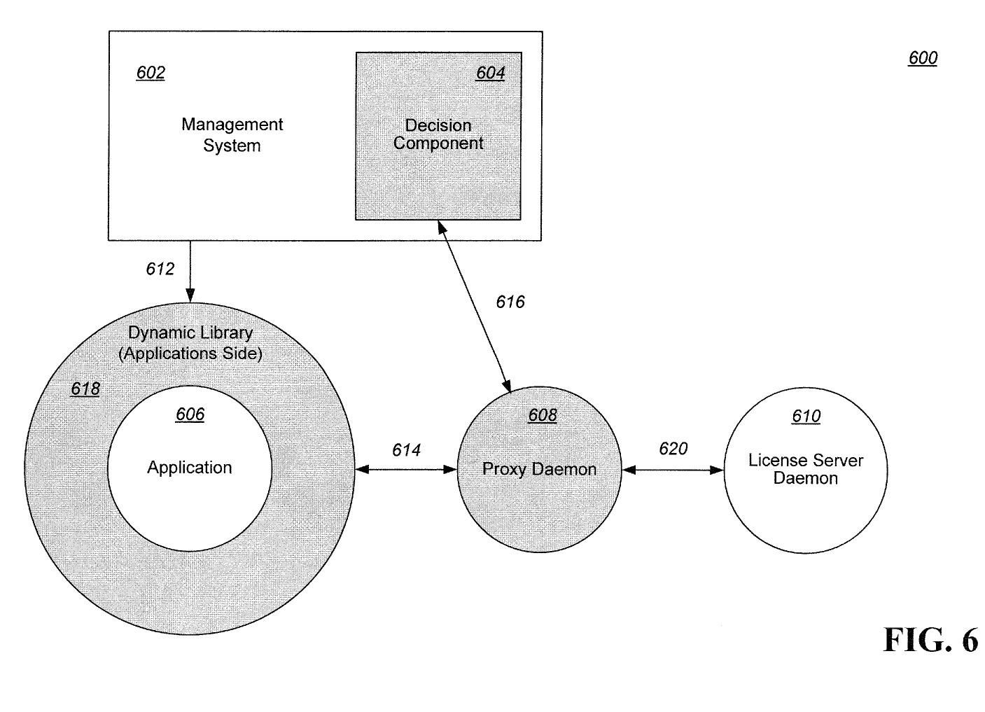

In another aspect, mechanism 600 could take the form of combining the previously described application side dynamic library with a licensing proxy service on the license server side, as illustrated in FIG. 6.

In this aspect, proxy service 608 intercepts connection requests via 614 from the application 606 on specific ports normally reserved by license server 610. If permitted by decision component 604, proxy service 608 relays those requests via 618 to license server 610. This indirection can be accomplished through existing mechanisms such as firewalls. This method along with restricting license server 610 to only accept connections from the local host would guarantee that proxy service 608 would be the only interface into the license server 610. Since the ports would remain the same, applications launched by any external entity having not been preloaded with dynamic library 618 would still be forced into using proxy service 608 to checkout licenses.

To check out a license, an application would try to make a connection to the license server. Through the aforementioned indirection mechanism those connections that originate from outside the host would be rerouted to proxy daemon 608 on the expected license server port. Decision component 604 would be consulted via 616 and if authorization is granted for the license, a real connection is made to license server 610 and the original request is relayed. If the license is denied by decision component 604, the communication will be gracefully terminated. The reply via 620, also being intercepted by proxy daemon 608, would request authorization via 616 from decision component 604 before relaying the response back to the application via 614.

The advantage of this implementation is that the license server would not have to be preloaded with a dynamic library and yet the entire solution would still remain transparent. Another advantage is that a single proxy service could provide support for multiple license servers being hosted on the same machine.

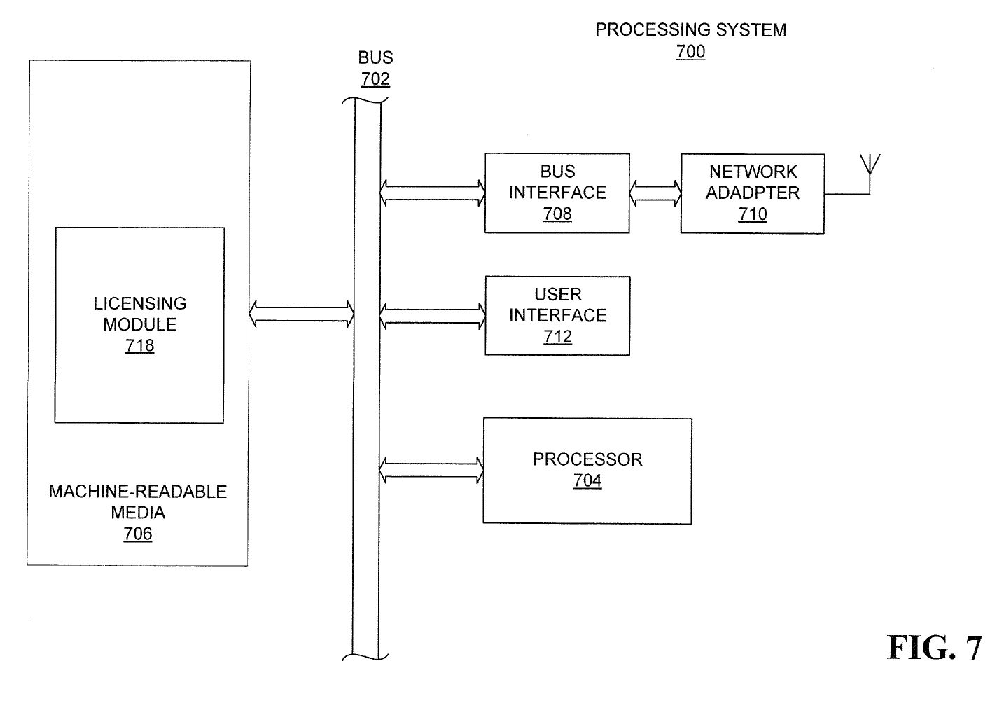

FIG. 7 is a conceptual diagram illustrating an example of a hardware configuration for a processing system 700 operable for license enforcement. In this example, the processing system 700 may be implemented with a bus architecture represented generally by bus 702. The bus 702 may include any number of interconnecting buses and bridges depending on the specific application of the processing system 700 and the overall design constraints. The bus links together various circuits including a processor 704, machine-readable media 706, and a bus interface 708. The bus interface 708 may be used to connect a network adapter 710, among other things, to the processing system 700 via the bus 702. The network interface 710 may be used to implement the signal processing functions of the PHY layer. A user interface 712 (e.g., keypad, display, mouse, joystick, etc.) may also be connected to the bus. The bus 702 includes a clock line (CLK) to communicate a clock. The bus 702 may also link various other circuits such as timing sources, peripherals, voltage regulators, power management circuits, and the like, which are well known in the art, and therefore, will not be described any further.

The processor 704 is responsible for managing the bus and general processing, including the execution of software stored on the machine-readable media 706. The processor 708 may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof The machine-readable may be embodied in a computer-program product. The computer-program product may comprise packaging materials.

In the hardware implementation illustrated in FIG. 7, the machine-readable media 706 is shown as part of the processing system 700 separate from the processor 704. However, as those skilled in the art will readily appreciate, the machine-readable media 706, or any portion thereof, may be external to the processing system 700. By way of example, the machine-readable media 706 may include a transmission line, a carrier wave modulated by data, and/or a computer product separate from the wireless node, all which may be accessed by the processor 704 through the bus interface 708. Alternatively, or in addition to, the machine readable media 704, or any portion thereof, may be integrated into the processor 704, such as the case may be with cache and/or general register files.

The processing system 700 may be configured as a general-purpose processing system with one or more microprocessors providing the processor functionality and external memory providing at least a portion of the machine-readable media 706, all linked together with other supporting circuitry through an external bus architecture. Alternatively, the processing system 700 may be implemented with an ASIC (Application Specific Integrated Circuit) with the processor 704, the bus interface 708, the user interface 712 in the case of an mobile station), supporting circuitry (not shown), and at least a portion of the machine-readable media 706 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system 700 depending on the particular application and the overall design constraints imposed on the overall system.

The machine-readable media 706 is shown with a number of software modules. The software modules include instructions that when executed by the processor 704 cause the processing system 700 to perform various functions. Each software module may reside in a single storage device or distributed across multiple storage devices. By way of example, a software module may be loaded into RAM from a hard drive when a triggering event occurs. During execution of the software module, the processor 704 may load some of the instructions into cache to increase access speed. One or more cache lines may then be loaded into a general register file for execution by the processor 704. When referring to the functionality of a software module below, it will be understood that such functionality is implemented by the processor 704 when executing instructions from that software module. In one aspect, a module 718 operable for license enforcement is provided.

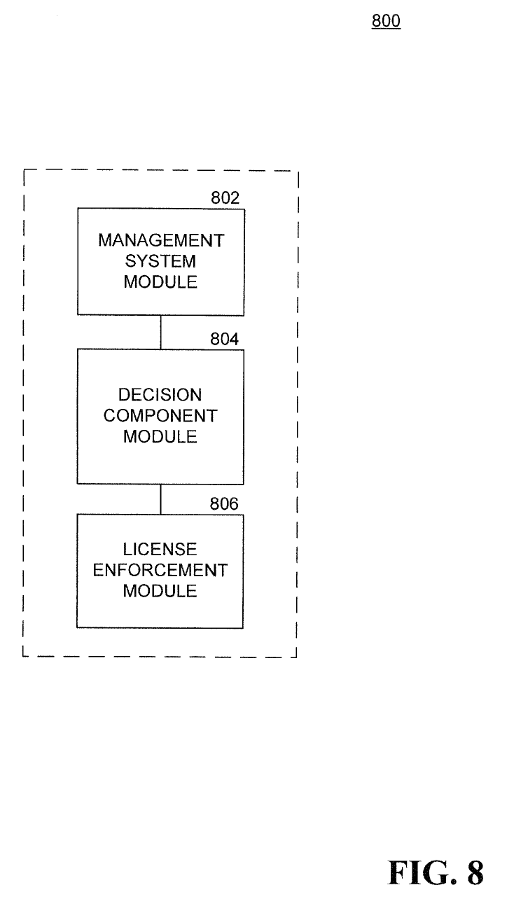

Referring now to FIG. 8, illustrated is a block diagram of an exemplary apparatus 800 having various modules operable for license enforcement. Management system module 802 may be operable for scheduling instances across the system resources, optimizing system resources, and prioritizing an instance. Decision component module 804 may be operable for determining whether a specific request form an instance or response from a license server should be permitted or denied. License enforcement module 806 may be operable for permitting or denying license requests by controlling which instance requests are allowed to reach a license server and controlling which license server responses reach an instance.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method for license enforcement comprising:
receiving a license request from an application instance;
determining whether the license request is permitted by generating a first response permitting or denying the license request;
delivering the license request to a server based upon the first response;
receiving a server response from the server permitting or denying the license request; and
determining whether the license request is permitted by generating a second response permitting or denying the license request.

2. The method of claim 1, further comprising:
controlling whether the license request is permitted based upon the first or second response.

3. The method of claim 2, wherein controlling further comprises:
forwarding the permitted license to the application instance; and
terminating the connection when the license request is denied.

4. The method of claim 1, wherein determining further comprises:
querying a decision component for the first and second response.

5. The method of claim 1, wherein receiving further comprises, receiving via a dynamic library.

6. The method of claim 5, wherein the server includes the dynamic library.

7. The method of claim 5, wherein the instance includes the dynamic library.

8. The method of claim 5, wherein the server includes a first dynamic library and the instance includes a second dynamic library.

9. The method of claim 1, wherein receiving further comprises, receiving via a proxy service.

10. An apparatus for license enforcement comprising:
means for receiving a license request from an application instance;
means for determining whether the license request is permitted by generating a first response permitting or denying the license request;
means for delivering the license request to a server based upon the first response;
means for receiving a server response from the server permitting or denying the license request; and
means for determining whether the license request is permitted by generating a second response permitting or denying the license request.

11. An apparatus for license enforcement comprising:
a memory for storing licenses; and
a processing system configured to:
receive a license request from an application instance;
determine whether the license request is permitted by generating a first response permitting or denying the license request;
deliver the license request to a server based upon the first response;
receive a server response from the server permitting or denying the license request; and
determine whether the license request is permitted by generating a second response permitting or denying the license request.

12. The apparatus of claim 11, further comprising:
a license enforcement module operable for controlling whether the license request is permitted based upon the first or second response.

13. The apparatus of claim 12, wherein controlling further comprises:
forwarding the permitted license to the application instance; and
terminating the connection when the license request is denied.

14. The apparatus of claim 11, wherein determining further comprises:
a decision component operable for determining the first and second response.

15. The apparatus of claim 11, wherein receiving further comprises, receiving via a dynamic library.

16. The apparatus of claim 15, wherein the server includes the dynamic library.

17. The apparatus of claim 15, wherein the instance includes the dynamic library.

18. The apparatus of claim 15, wherein the server includes a first dynamic library and the instance includes a second dynamic library.

19. The apparatus of claim 11, wherein receiving further comprises, receiving via a proxy service.

20. A computer-program product for license enforcement, comprising:
a machine-readable medium with instructions stored thereon executable to:
receive a license request from an application instance;
determine whether the license request is permitted by generating a first response permitting or denying the license request;
deliver the license request to a server based upon the first response;
receive a server response from the server permitting or denying the license request; and
determine whether the license request is permitted by generating a second response permitting or denying the license request.
